(19) United States
(12) Patent Application Publication
(10) Pub. No.: US 2004/0183626 A1
(43) Pub. Date: Sep. 23, 2004

(54) Electronically tunable block filter with tunable transmission zeros

(76) Inventors: Qinghua Kang, Newark, DE (US); Khosro Shamsaifar, Ellicott City, MD (US)

Correspondence Address: James S. Finn, #2825, 8650 Southwestern Blvd., Dallas, TX, 75206-2688, US

(21) Appl. No.: 10/742,739

(22) Filed: Dec. 19, 2003

Related U.S. Application Data
(60) Provisional application No. 60/445,349, filed on Feb. 5, 2003.

(51) Int. Cl. H01P 1/205

(52) U.S. Cl. 333/207

(57) ABSTRACT

A voltage-controlled tunable filter that comprises at least one coaxial combline resonator that includes at least one metallized through-hole, an input/output coupling metallization on at least one surface of said at least one coaxial combline resonator, at least one tunable varactor associated with said at least one coaxial combline resonator, and an inter-pole-and-port cross coupling component cross coupling a filter pole of said at least one combline resonator and said at least one input-output coupling metallization. At least one DC biasing point can be included to provide voltage to said at least one tunable varactor. In a preferred embodiment, the at least one tunable varactor is four tunable varactors and the least least one input/output coupling metallizations is two input/output coupling metallizations. The voltage-controlled tunable filter can be a monoblock voltage controlled tunable filter or a coaxial block voltage controlled tunable filter. Also, in a preferred embodiment, the inter-pole-and-port cross coupling component can provide either a variable capacitive cross coupling, a variable inductive cross coupling or a variable capacitive and inductive cross coupling.

### CROSS-REFERENCE TO RELATED APPLICATION

This application claims priority to U.S. Provisional Patent Application Serial No. 60/445,349, “ELECTRONICALLY TUNABLE BLOCK FILTER WITH TUNABLE TRANSMISSION ZEROS” filed Feb. 5, 2003, by Qinghua Kang et al.

### BACKGROUND OF THE INVENTION

The present invention relates generally tunable capacitors, tunable filters, tunable dielectrics and tunable transmission zeros.

In mobile communications, compact and low cost RF components are always desirable. Often RF filters in these radio communication systems occupy relatively large and expensive real estate on the circuit board. High-Q dielectric ceramic resonators with a high dielectric constant can efficiently reduce the size of filters. If a ceramic filter can be electronically tuned to cover the application frequency band which conventionally requires several fixed filters, then the part counts and circuit volume can be further reduced. It also results in the reduction of cost.

Compared to mechanically and magnetically tunable filters, electronically tunable filters have the most important advantage of fast tuning capability over wide frequency band applications. Because of this advantage, they can be used in the applications such as LMDS (local multipoint distribution service), cellular, PCS (personal communication system), frequency hopping, satellite communication, and radar systems. As for the electronically tunable filters, there are two different types of these filters: one is voltage-controlled tunable dielectric capacitor based tunable filters and the other is semiconductor varactor based tunable filters. Compared to semiconductor varactor based tunable filters, tunable dielectric capacitor based tunable filters have the merits of lower loss, higher power-handling, and higher IP3, especially at higher frequencies.

Inherent in every tunable filter is the ability to rapidly tune the response using high-impedance control lines. Parascan®, the trademarked name for tunable materials technology developed by the assignee of the present invention, enables these tuning properties, as well as, high Q values, low losses and extremely high IP3 characteristics, even at high frequencies. MEMS based varactors can also be used for this purpose. They use different bias voltages to vary the electrostatic force between two parallel plates of the varactor and hence change its capacitance value. They show lower Q than dielectric varactors, and have worse power handling, but can be used successfully for some applications. Also, diode varactors could be used to make tunable filters, although with worse performance than with dielectric varactors.

In filter design, the bandwidth of a filter can be synthesized over specific frequency band applications. Typically, in order to achieve a steeper rejection in the signal frequency stopband of a bandpass filter, the filter structure will be in favor of increasing filter poles or using extremely high Q resonators. In many practical applications these requirements will be prohibitive.

Therefore, a strong need in the industry exists for tunable capacitors, tunable filters, tunable dielectric and tunable transmission zeros with the aforementioned properties and without the above articulated shortcomings of the prior art solutions.

### SUMMARY OF THE INVENTION

The present invention provides a voltage-controlled tunable filter that comprises at least one coaxial combline resonator that includes at least one metallized through-hole, an input/output coupling metallization on at least one surface of said at least one coaxial combline resonator, at least one tunable varactor associated with said at least one coaxial combline resonator, and an inter-pole-and-port cross coupling component cross coupling a filter pole of said at least one combline resonator and said at least one input-output coupling metallization. At least one DC biasing point can be included to provide voltage to said at least one tunable varactor. In a preferred embodiment the at least one tunable varactor is four tunable varactors and the least one input/output coupling metallizations is two input/output coupling metallizations. The voltage-controlled tunable filter can be a monoblock voltage controlled tunable filter or a coaxial block voltage controlled tunable filter. Also, in a preferred embodiment, the inter-pole-and-port cross coupling component can provide either a variable capacitive cross coupling, a variable inductive cross coupling or a variable capacitive and inductive cross coupling.

The present invention also provides an RF filter which includes at least one block of dielectric material, at least one metallized through hole within said at least one block of dielectric material where the at least one block of dielectric material has an electrode pattern that adheres to at least one surface of said block. The electrode pattern consists of a photodefinable metallization covering at least one surface of said block of dielectric material converted to a photodefined patterned metallization on at least one surface of said dielectric material and wherein said metallization includes at least one input/output coupling metallization and also includes at least one tunable varactor. Also an inter-pole-and-port cross coupling component cross coupling a filter pole of said at least one block of dielectric material and said at least one input-output coupling metallization is included in this embodiment. This embodiment of the RF filter of the present invention further comprises at least one additional block of dielectric material connected via an iris between said block of dielectric material and said at least one additional block of dielectric material. Also included in the present embodiment is at least one DC biasing point for providing voltage to said at least one tunable varactor. The inter-pole-and-port cross coupling component cross coupling a filter pole of said at least one block of dielectric material and said at least one input-output coupling metallization provides either variable capacitive cross coupling or variable inductive cross coupling or variable capacitive and inductive cross coupling.

Yet another embodiment of the present invention provides a method of tuning transmission zeros using a voltage-controlled tunable filter comprising the steps of providing at least one coaxial combline resonator wherein said at least one coaxial combline resonator includes at least one metallized through-hole and an input/output coupling metallization on at least one surface of said at least one coaxial combline resonator, varying the capacitance of a varactor by using at least one tunable varactor associated with said at least one coaxial combline resonator, and cross coupling a filter pole of said at least one combline resonator and said at least one input-output coupling metallization with an inter-pole-and-port cross coupling component. This method can also comprise providing at least one DC biasing point for providing voltage to said at least one tunable varactor. Further, said at least one tunable varactor can be four or more tunable varactors. Further, said least one input/output coupling metallization on at least one surface of said at least one coaxial combline resonator can be two input/output coupling metallization on at least one surface of said at least one coaxial combline resonator. Also, said voltage-controlled tunable filter can be a monoblock voltage controlled tunable filter or a coaxial block voltage controlled tunable filter. The step of cross coupling a filter pole of said at least one combline resonator and said at least one input-output coupling metallization with an inter-pole-and-port cross coupling component can provide variable capacitive cross coupling, variable inductive cross coupling or variable capacitive and inductive cross coupling.

Yet another embodiment of the present invention provides a voltage-controlled tunable filter that includes at least one coaxial combline resonator that includes and at least one metallized through-hole; a plurality of input/output coupling metallizations on at least one surface of said at least one coaxial combline resonator; at least one tunable varactor associated with said at least one coaxial combline resonator; and an inter-pole-and-port cross coupling component cross coupling at least two of said plurality of input/output coupling metallizations. This embodiment can further include at least one DC biasing point for providing voltage to said at least one tunable varactor. Also, the least one tunable varactor can be four or more tunable varactors and wherein said plurality of one input/output coupling metallizations on at least one surface of said at least one coaxial combline resonator is two input/output coupling metallizations on at least one surface of said at least one coaxial combline resonator and said two input/output coupling metallizations are cross coupled by an inter-pole-and-port cross coupling component. The voltage-controlled tunable filter is a monoblock voltage controlled tunable filter or a coaxial block voltage controlled tunable filter. The inter-pole-and-port cross coupling component cross coupling at least two of said plurality of input/output coupling metallizations provides variable capacitive cross coupling, variable inductive cross coupling or variable capacitive and inductive cross coupling.

### BRIEF DESCRIPTION OF THE DRAWINGS

FIG. 1 shows a two-pole tunable mono block filter;

FIG. 2 shows a tunable two-pole mono block filter with tunable inter-pole-and-port cross coupling component;

FIG. 3 shows the equivalent circuit for the filter shown in FIG. 2;

FIG. 4 shows the frequency response of capacitive cross coupling at inter-pole-and-port in a tunable two-pole bandpass filter;

FIG. 5 shows the frequency response of inductive cross coupling at inter-pole-and-port in a tunable two-pole bandpass filter;

FIG. 6 shows the equivalent circuit having mixed-nature cross coupling at inter-pole-and-port in a tunable two-pole bandpass filter;

FIG. 7 shows the frequency response of the mixed-nature cross coupling at inter-pole-and-port in a tunable bandpass filter;

FIG. 8 shows a tunable two-pole monoblock filter with tunable inter-port cross coupling component;

FIG. 9 shows the equivalent circuit for the filter shown in FIG. 8;

FIG. 10 shows the frequency response of capacitive cross coupling at inter-port in a tunable two-pole bandpass filter;

FIG. 11 shows the frequency response of inductive cross coupling at inter-port in a tunable two-pole bandpass filter;

FIG. 12 shows the equivalent circuit having mixed-nature cross coupling at inter-port in a tunable two-pole bandpass filter; and

FIG. 13 shows the frequency response of the mixed-nature cross coupling at inter-port in a tunable bandpass filter.

### DESCRIPTION OF THE PREFERRED EMBODIMENT

The addition of transmission zeroes to the bandpass filter's frequency response could effectively improve the performance of the ceramic block filter in rejecting undesired signals. When the locations of transmission zeros are made tunable in the frequency band application, the performance of the ceramic block bandpass filter can be improved further.

The present invention is an electronically tunable filter made in dielectric block having controllable transmission zeros. The tuning elements are voltage-controlled tunable dielectric capacitors placed on the ceramic block. Alternatively, MEMS varactors or diode varactors can be used to make tunable filters, although with limited applications. Since the tunable capacitors show high Q, high IP3 (low inter-modulation distortion) and low cost, the tunable filter in the present invention has the advantage of low insertion loss, fast tuning speed, and high power handling. The present technology makes tunable filters very promising in the contemporary communication system applications.

Within the ceramic block filter applications, there are two categories of filter implementations based on the filter structural features, which result in different manufacturing abilities. One is the coaxial block configuration in which each block resonator possesses a quarter-wavelength coaxial transmission line form with one end shorted. The coupling between adjacent resonators is obtained via the aperture formed on the common wall between the resonators, and is controlled by the aperture size and position. The other ceramic block filter configuration is the monoblock in which the resonators are formed in a single ceramic block as plural through-holes with metallized surfaces. The coupling between the resonators is controlled by the distance between them. Usually monoblock ceramic filters provide easier manufacturing process and therefore can be made less expensively. To provide tunability to the ceramic block filter, Parascan® dielectric varactors are attached to the resonators to tune the resonant frequencies and then center frequency of the filter.

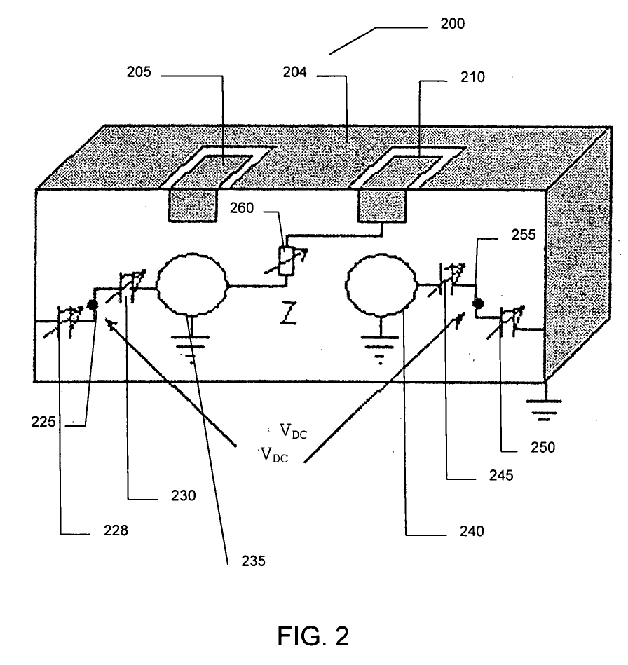

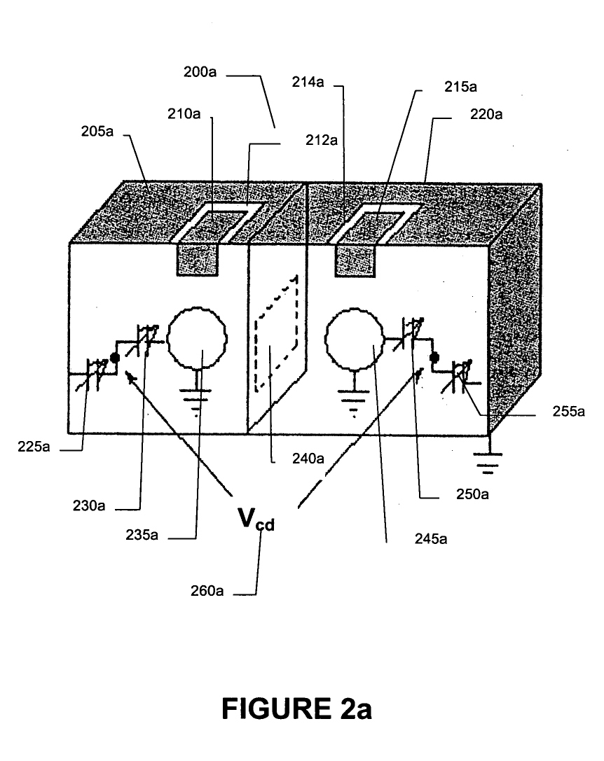

The present invention provides a voltage-tuned filter with tunable transmission zeros having low insertion loss, fast tuning speed, high power-handling capability, high IP3 and low cost in the microwave frequency range. With tunable transmission zeros, this voltage-tuned filter also possesses superior performance in the frequency stopband. Although one preferred embodiment of the present invention is a tunable bandpass filter with tunable transmission zeros based on the monoblock ceramic filter configuration and is described herein in greater detail, it is equivalently applicable to the coaxial ceramic block filters described in FIG. 2a below. Compared to MEMS varactors or voltage-controlled semiconductor varactors, voltage-controlled tunable capacitors have higher Q factors, higher power-handling and higher IP3.

The tunable dielectric capacitor in the present invention is made from low loss tunable dielectric film. The range of Q factor of the tunable dielectric capacitor is between 50, for very high tuning material, and 300 or higher, for low tuning material. It also decreases with increasing frequency, but even at higher frequencies, say 30 GHz, values can be as high as 100. A wide range of capacitance of the tunable dielectric capacitors is available, from 0.1 pF to several pF. The tunable dielectric capacitor is a packaged two-port component, in which the tunable dielectric can be voltage-controlled. The tunable film is deposited on a substrate, such as MgO, LaAIO3, sapphire, AhO3 or other dielectric substrates. An applied voltage produces an electric field across the tunable dielectric, which produces an overall change in the capacitance of the tunable dielectric capacitor.

The tunable capacitors with microelectromachanical system (MEMS) technology can also be used in the tunable filter and are part of this invention. At least two varactor topologies can be used, parallel plate and interdigital. In parallel plate structure, one of the plates is suspended at a distance from the other plate by suspension springs. This distance can vary in response to electrostatic force between two parallel plates induced by applied bias voltage. In the interdigital configuration, the effective area of the capacitor is varied by moving the fingers comprising the capacitor in and out and changing its capacitance value. MEM varactors have lower Q than their dielectric counterpart, particularly at higher frequencies, and have worse power handling, but can be used in certain applications.

In another embodiment, the tunable ceramic block filters based on both of the coaxial and monoblock configurations can be utilized and tunability to the block filters is provided by Parascan® dielectric varactors. For example, a tunable monoblock filter consists of one dielectric block which has several metallized holes to form the inner conductors of resonators. These resonators are quarter wavelength TEM mode transmission lines with one end shorted.

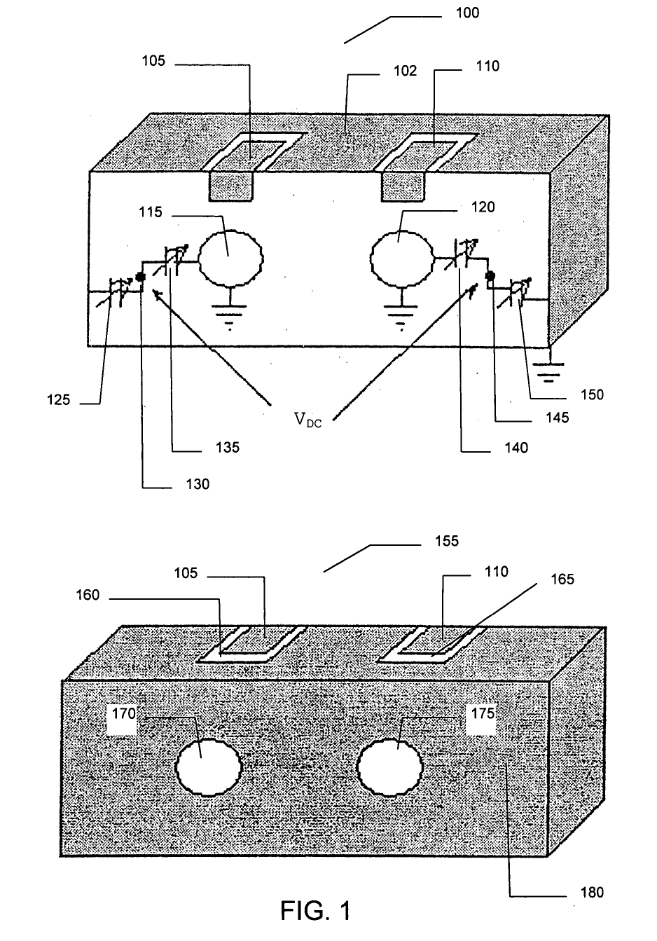

Turning now to the Figures, FIG. 1 shows one typical configuration of a tunable monoblock ceramic filter with two poles shown generally as 100. It consists of one coaxial combline resonator 102 (although as will be described below, additional combline resonators can be combined). One end of the resonator 102 is open and the other end is short. The access coupling to the resonator 102 is achieved by a probe, which consists of a metallizing part of the dielectric at the open end of the resonators, as shown in FIG. 1 at 105 and 110. All other surfaces are metallized ground. The input/output coupling metallization 105 and 110 has been extended to the perpendicular surface and isolated as shown for SMD applications. Also depicted in FIG. 1 in the front view are the metallized through holes in the ceramic blocks at 115 and 120.

The outer surfaces of the block, except partial top surface and some areas immediately surrounding the I/O ports, are covered with metal. As shown in FIG. 1 the dark area designates the metallization layer and open areas are the dielectric material exposed. To provide tunability to this filter, one or two tunable varactors will be placed near the open end of the resonator, as shown in FIG. 1 at 125, 135, 140 and 150. DC bias points 130 and 145 provide a DC bias for the aforementioned tunable varactors 125, 135, 140 and 150. Physically these components can be mounted in two different ways: directly on the resonator block and on the board off the block. However, the resultant unloaded filter quality factor Q will be significantly degraded if the tuning parts are located off the block on the board other than integrated on the resonator block. Filters with higher number of poles will be made by simply adding more resonators between the two shown in the following Figures. The back side of resonator 100 is shown at 155 of FIG. 1. Herein, 170 and 175 depict the back side of metallized through holes 115 and 120 of the resonator 100 and also input/output coupling metallization 105 and 110 which can be seen to be extended to the perpendicular surface and isolated as shown by isolated portion 160 and 165

To create transmission zeros in the bandpass filter frequency stopband at low side, high side, or split at the passband, desired cross coupling between filter pole and I/O port has to be achieved. By controlling the cross coupling, tunable transmission zeros can be obtained and filter performance can be further trimmed to meet specific requirements.

FIG. 2 shows a tunable two-pole monoblock filter with tunable inter-pole-and-port cross coupling component 260 which can be either capacitive or inductive. In other respects, FIG. 2 is similar to FIG. 1. To wit, FIG. 2 shows one typical configuration of a tunable monoblock ceramic filter with two poles shown generally as 200. It consists of one coaxial combline resonator 204 One end of the resonator 204 is open and the other end is short. The access coupling to the resonator 204 is achieved by a probe, which consists of a metallizing part of the dielectric at the open end of the resonators, as shown in FIG. 2 at 205 and 210. All other surfaces are metallized ground. The input/output coupling metallization 205 and 210 has been extended to the perpendicular surface and isolated as shown in FIG. 1. Also depicted in FIG. 2 in the front view are the metallized through holes in the ceramic blocks at 235 and 240.

As with FIG. 1, the outer surfaces of the block of FIG. 2, except partial top surface and some areas immediately surrounding the I/O ports, are covered with metal. Again, as shown in FIG. 1, the dark area of FIG. 2 designates the metallization layer and open areas are the dielectric material exposed. To provide tunability to this filter, one or two tunable varactors will be placed near the open end of the resonator, as shown in FIG. 228, 230, 245 and 250. DC bias points 225 and 255 provide a DC bias for the aforementioned tunable varactors 228, 230, 245 and 250. Again, as with FIG. 1, physically these components can be mounted in two different ways: directly on the resonator block and on the board off the block. However, the resultant unloaded filter quality factor Q will be significantly degraded if the tuning parts are located off the block on the board other than integrated on the resonator block.

As mentioned above, in addition to the tunable two-pole monoblock filter, herein is provided a coaxial block configuration in which each block resonator possesses a quarter-wavelength coaxial transmission line form with one end shorted. The coupling between adjacent resonators is obtained via the aperture formed on the common wall between the resonators, and is controlled by the aperture size and position. As mentioned above, filters with a higher number of poles can be made by simply adding more resonators between the two resonators as shown in FIG. 2a at 200a with resonators 205a and 220a coupled by iris 240a. Metallized through holes in the ceramic are depicted at 235a and 245a and tunable varactors are integrated with resonators at 230a and 250a. Additional tunable varactors can be added as well as shown at 225a and 255a with DC bias voltage provided at 260a. Again, input/output coupling metallization is depicted at 210a and 215a with areas of non-metallization used for isolation shown at 212a and 214a. The tunable inter-pole-and-port cross coupling component (not shown in FIG. 2a) can be either capacitive or inductive.

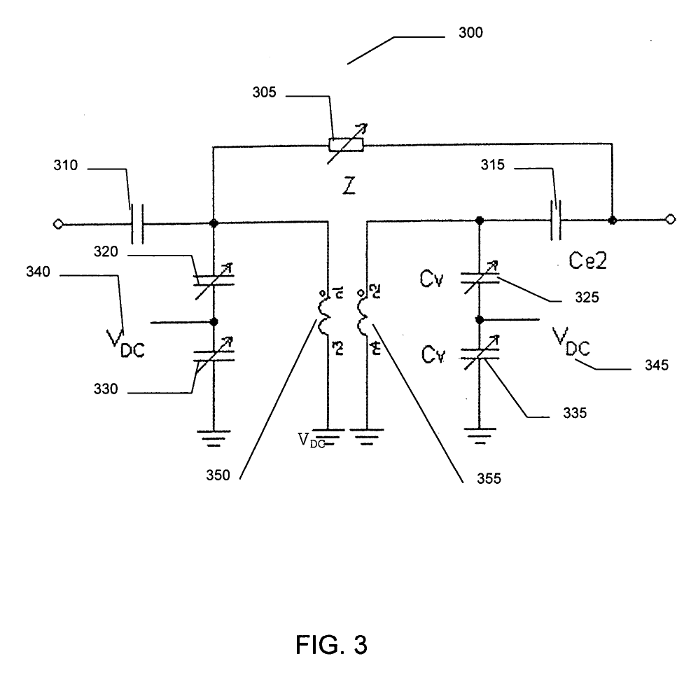

The equivalent circuit of the tunable two-pole monoblock filter with tunable inter-pole-and-port cross coupling component is shown in FIG. 3, generally at 300, wherein inter-pole-and-port tunable component is depicted at 305 and capacitance representing RF port coupling is shown at 310 and 315. Tunable varactors are depicted in the circuit at 320, 325, 330 and 335 with DC bias point at 340 and 345. 350 is a mutual coupled inductor representing left-side pole and 355 is a mutual coupled inductor representing right-side pole.

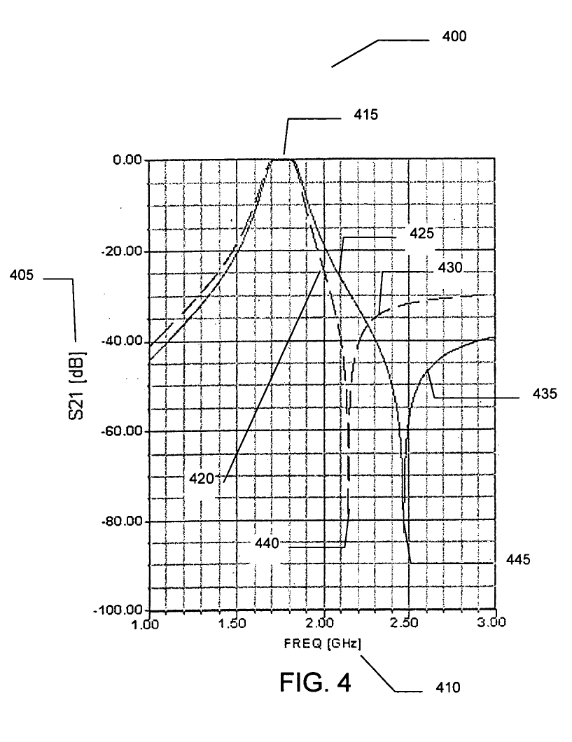

If in FIG. 2 or FIG. 3, the reactive component is a changeable capacitor (i.e. a varactor), a transmission zero at the high side of the passband can be achieved and is tunable as shown in FIG. 4, wherein there is shown generally at 400 the frequency response of capacitive cross coupling at inter-pole-and-port in a tunable two-pole bandpass filter. In this plot, mutually coupled inductors represent magnetically coupled two metallized through holes and Cv designates the varactors. In each pole, one varactor, which includes the capacitance from the open end as shown in FIG. 1 and FIG. 2, is used for tuning the frequency band; the other varactor provides DC blocking and can be replaced by a capacitor with fixed, high value for higher tunability. Cₑ₁ and Cₑ₂ represent the input and output coupling which results from the I/O ports located at the open end. By incorporating a reactive component (Z=jωL=1/jωC) into the two-pole filter between one port and its nonadjacent pole, transmission zeros can be created due to the presence of cross coupling. In addition the fact that this filter can be made tunable over its frequency band for specific applications, the transmission zeros can also be created selectively and made tunable. Specifically in FIG. 4, 405 depicts the Y-axis frequency response as S21 in dB. 410 represents X-axis frequency response in GHz. 415 depicts the filter passband with tuned transmission zeros and 420 illustrates the frequency response with a transmission zero closer. 425 shows the frequency response with a transmission zero away. 430 is the high-side rejection level for a closer transmission zero and 435 the high-side rejection level for an away transmission zero. 440 is the closer transmission zero and 445 is the away transmission zero.

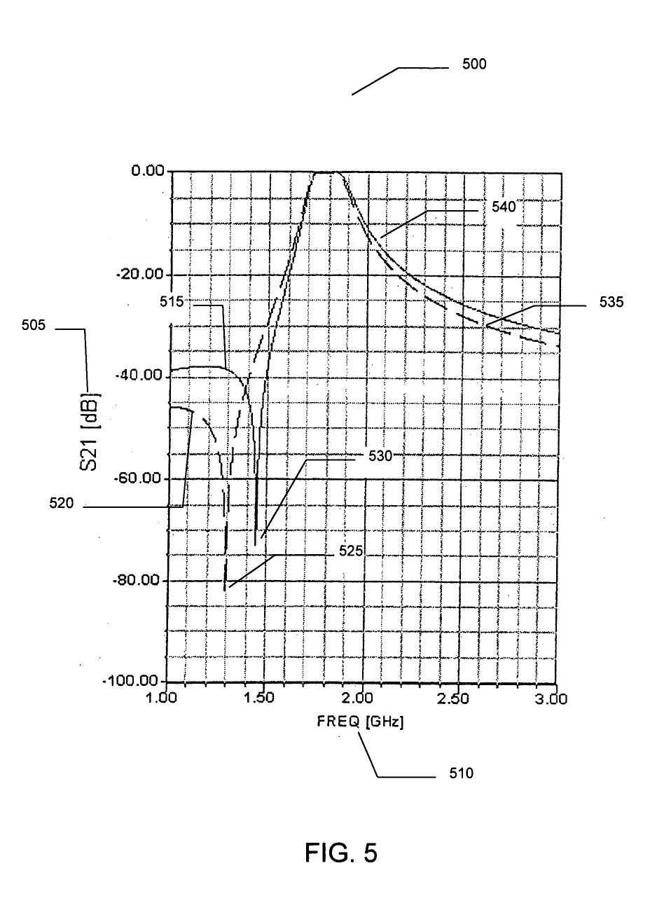

If the reactive component (Z) is a changeable inductor (or equivalent effect), a transmission zero at the low side of the passband can be achieved and tunable as shown in FIG. 5, wherein the frequency response of the two-pole bandpass filter with inductive inter-pole-and-port tunable coupling is shown generally as 500. 505 depicts the Y-axis frequency response as S21 in dB. 510 represents the X-axis frequency response in GHz. 515 depicts the low-side rejection level for a closer transmission zero and 520 shows the low-side rejection level for an away transmission zero. 525 shows the frequency response with a transmission zero away and 530 shows the closer transmission zero. At 535 is shown the high-side rejection level for an away transmission zero and at 540 is shown the high-side rejection level for a closer transmission zero.

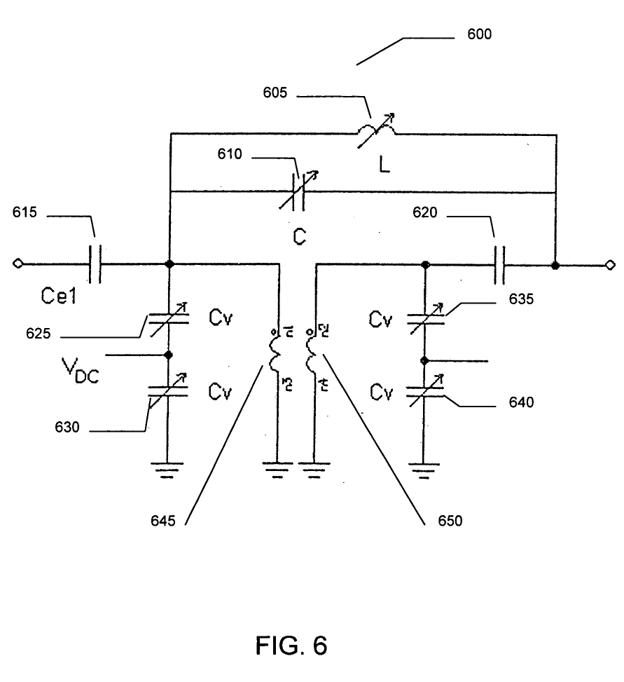

The cross coupling can be mixed in nature of both capacitive and inductive and is illustrated in the circuit shown in FIG. 6. Shown generally as 600 is an equivalent circuit of two-pole monoblock filter with both capacitive and inductive inter-pole-and-port tunable coupling. Herein 605 is an inter-pole-and-port tunable inductor, 610 is an inter-pole-and-port tunable capacitor, 615 and 620 are capacitance representing RF port coupling and finally 625, 630 and 640 are tunable varactors. 645 is a mutual coupled inductor representing left-side pole, and 650 is a mutual coupled inductor representing right-side pole.

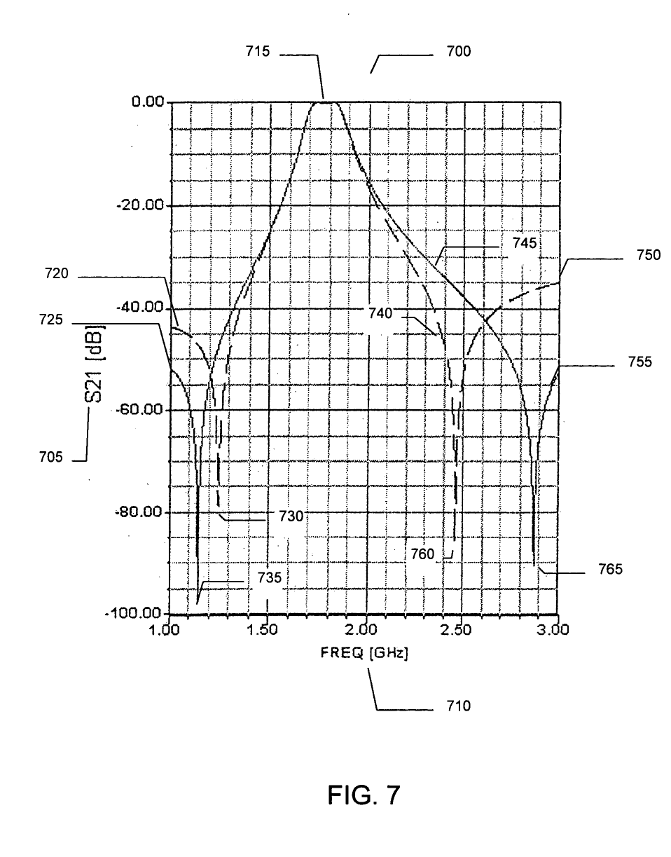

The result of the circuit of FIG. 6 is split transmission zeros around the passband and can be obtained and tuned when the cross coupling is controllable as shown in FIG. 7. FIG. 7 shows the frequency response of a two-pole bandpass filter with both capacitive and inductive inter-pole-and-port tunable coupling. 705 is the frequency response as S21 in dB with 710 being the frequency range in GHz. 715 shows the filter passband with tuned transmission zeros and 720 illustrates the low-side rejection level for closer transmission zeros. Further, 725 represents the Low-side rejection level for away transmission zeros. 730 shows the closer transmission zero at lower side of passband and 735 shows the away transmission zero at lower side of passband. 740 illustrates the frequency response with transmission zeros closer and 745 illustrates the frequency response with transmission zeros away. Looking at 750 is shown the high-side rejection level for closer transmission zeros and at 755 the high-side rejection level for away transmission zeros. Shown at 760 is the closer transmission zero at the higher side of the passband and at 765 is shown the away transmission zero at higher side of the passband.

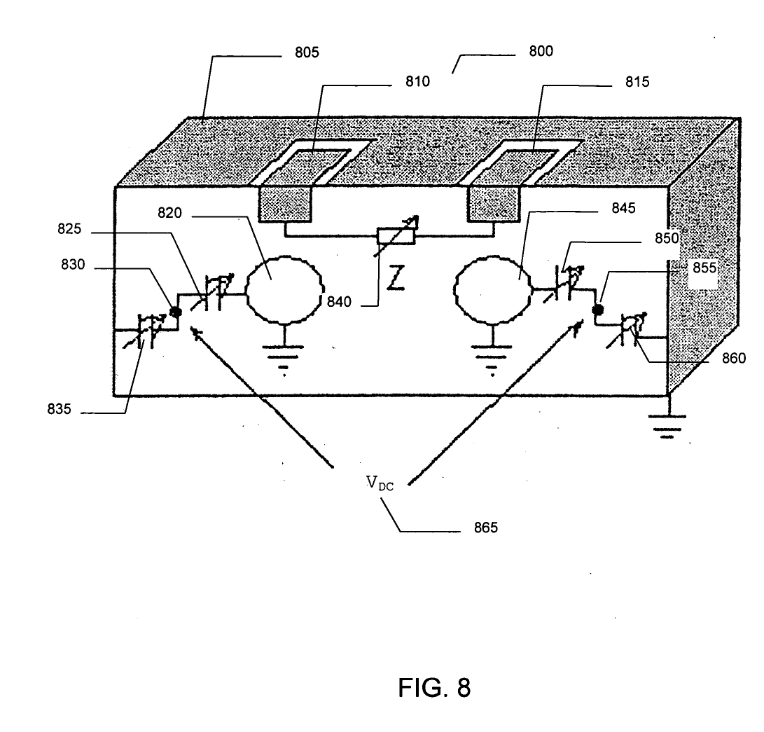

With the controllable cross coupling between the I/O ports with the embodiment of capacitive and/or inductive changeable components, tunable transmission zeros can also be created to improve the bandpass filter performance. FIG. 8, shown generally as 800, depicts a turnable two-pole mono block filter with a tunable inter-port cross coupling component which can be either capacitive or inductive. The respective components are as follows:

805 Metalized surface of ceramic block

810 RF I/O port

815 RF I/O port

820 Metalized thruhole in the ceramic block

825 Tunable varactor

830 DC bias point

835 Tunable varactor

840 Inter-port tunable component

845 Metalized thruhole in the ceramic block

850 Tunable varactor

855 DC bias point

860 Tunable varactor

865 DC bias voltage

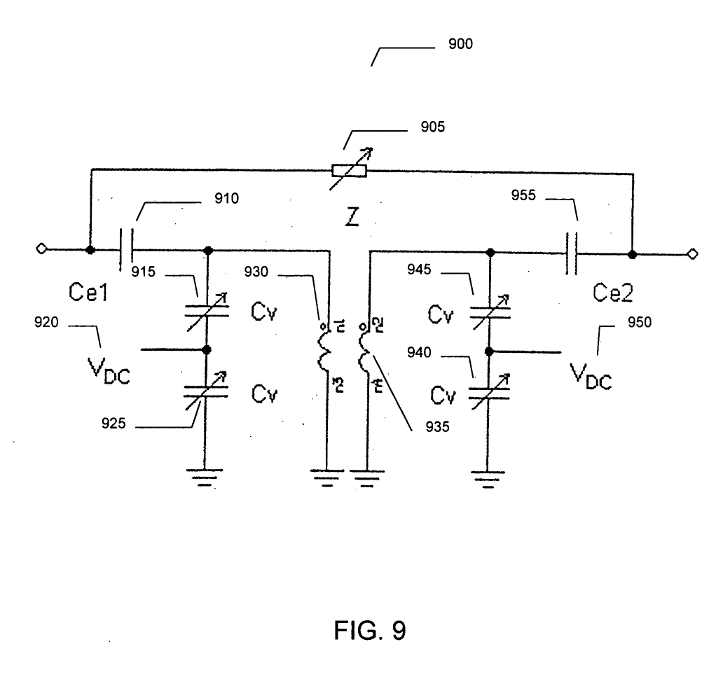

The equivalent circuit of the tunable two-pole monoblock filter with tunable interport coupling of FIG. 8 is shown in FIG. 9 at 900, wherein, 905 illustrates the inter-port tunable component. 910 shows the capacitance representing RF port-coupling and 915, 925, 940 and 945 represent the tunable varactors. DC bias points are represented by 920 and 950, with 930 representing mutual coupled inductor representing left-side pole and 935 representing mutual coupled inductor representing right-side pole. Finally, 955 illustrates the capacitance representing RF port coupling.

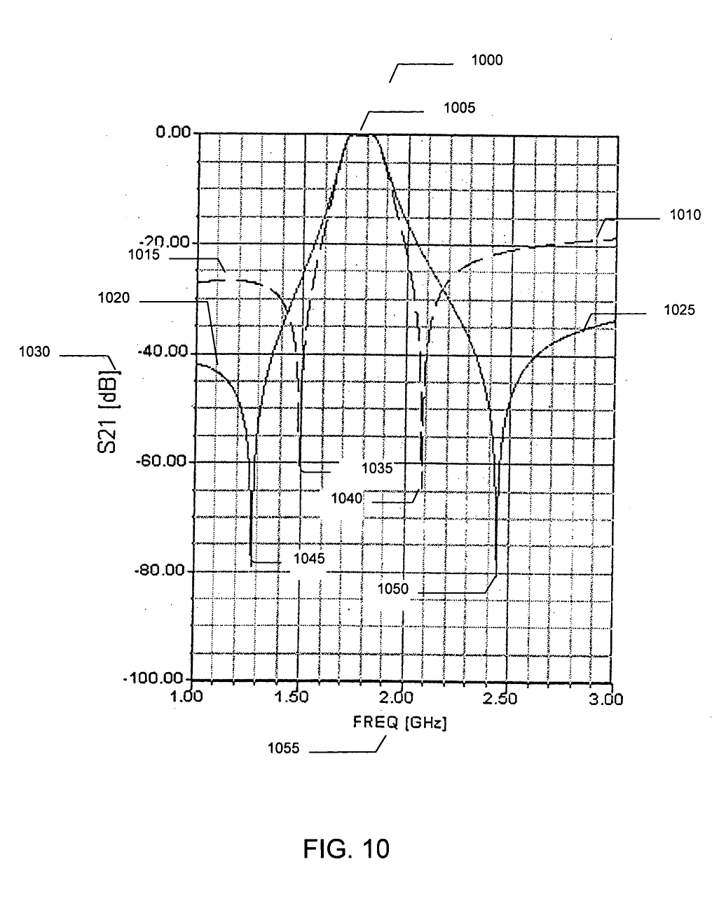

If in FIG. 8 or FIG. 9, the reactive component is a changeable capacitor (i.e. a varactor), split transmission zeros at both sides of the passband can be obtained and tuned by changing the capacitor value as show in FIG. 10. FIG. 10 thus illustrates generally at 1000, the frequency response of a two-pole bandpass filter with capacitive inter-port tunable cross coupling. The Y-Axis is depicted at 1030 which shows the frequency response as S21 in dB and the X-axis is depicted at 1055 which shows the frequency range in GHz. In this graph is shown at 1005 the filter passband with tuned transmission zeros; at 1010 the high-side rejection level for closer transmission zeros; at 1015 the low-side rejection level for closer transmission zeros; at 1020 is the high-side rejection level for away transmission zeros; at 1025 the low-side rejection level for away transmission zeros; at 1035 the closer transmission zero at lower side of passband; at 1040 the closer transmission zero at higher side of passband; at 1045 the away transmission zero at lower side of passband; and at 1050 the away transmission zero at higher side of passband.

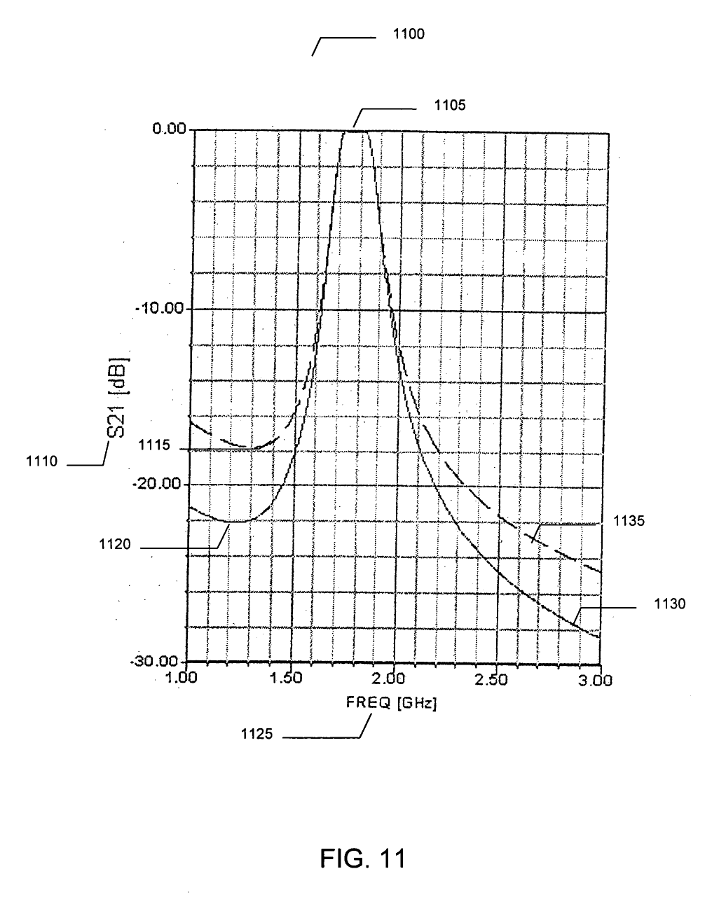

If the reactive component is a changeable inductor (or equivalent effect), improved frequency performance around the passband is achieved and controllable by changing the inductive cross coupling as show in FIG. 11. FIG. 11 illustrates the frequency response of a two-pole bandpass filter with inductive inter-port tunable cross coupling. X-axis is shown at 1125 illustrating the frequency range in GHz. Y-axis is illustrated at 1110 which shows the frequency response as S21 in dB. At 1105 is the filter passband with tuned transmission zeros; at 1115 is the low-side rejection level for closer transmission zeros; at 1120 is the low-side rejection level for away transmission zeros; at 1130 is the high-side rejection level for away transmission zeros; and at 1135 is the high-side rejection level for closer transmission zeros.

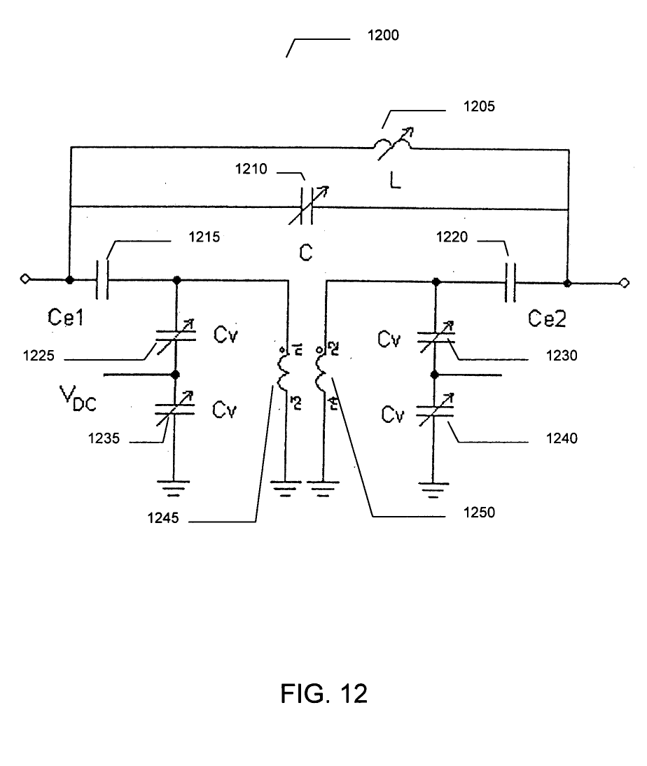

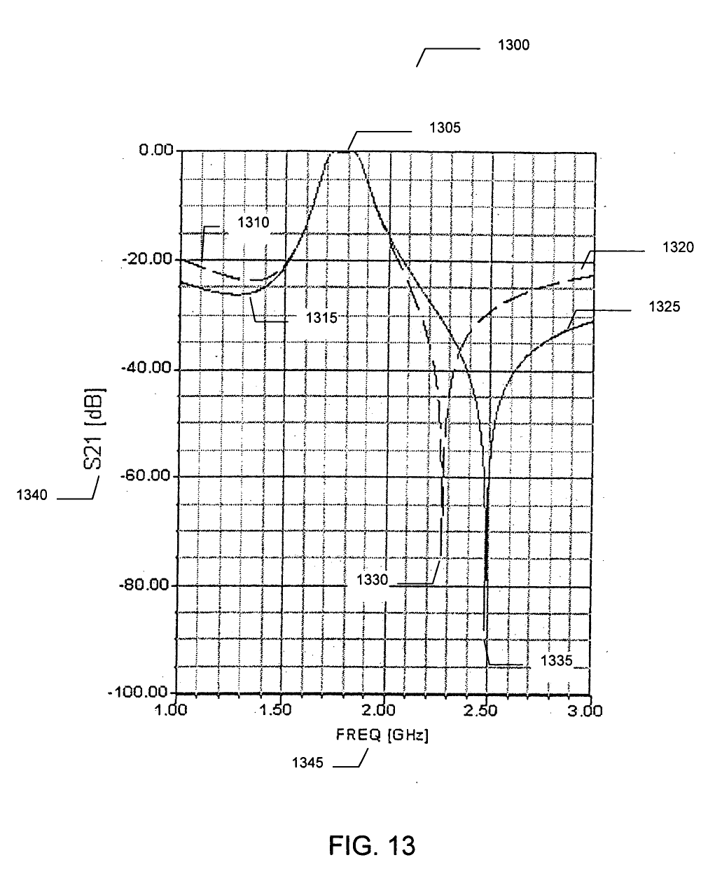

If the cross coupling is mixed in nature of both capacitive and inductive as shown in FIG. 12, filter response with high side transmission zero and improved performance at low side can be obtained and tuned when the cross coupling is controllable as show in FIG. 13. FIG. 12 at 1200 depicts the equivalent circuit of a tunable two-pole monoblock filter with both tunable capacitive and inductive inter-port coupling. Specifically, the circuit includes at 1205 and 1210 inter-port tunable inductive and capacitive components respectively; at 1215 and 1220 is represented capacitance representing RF port coupling; 1225, 1230, 1235, and 1240 represent tunable varactors; 1245 and 1250 respectively represent mutual coupled inductor representing left-side and right-side poles.

Again FIG. 13 at 1300 represents the frequency response of two-pole bandpass filter with both capacitive and inductive inter-port tunable cross coupling, with the Y-Axis shown at 1340 and representing the frequency response as S21 in dB and X-axis at 1345 representing the frequency range in GHz. Further: 1305 illustrates the filter passband with tuned transmission zeros; 1310 illustrates the frequency response with transmission zeros closer; 1315 shows the frequency response with transmission zeros away; 1320 shows the high-side rejection level for closer transmission zeros; 1325 the high-side rejection level for away transmission zeros; 1330 the closer transmission zero at higher side of passband; and 1335 the away transmission zero at higher side of passband.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks or basic illustrations illustrating the performance of specified functions and relationships thereof. The boundaries of these illustrations and functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. Thus, the breadth and scope of the present invention should not be limited by any of the above-described exemplary embodiments, but should be defined only in accordance with the following claims and their equivalents.

What is claimed is:

1. A voltage-controlled tunable filter, comprising:
at least one coaxial combline resonator;
said at least one coaxial combline resonator includes and at least one metallized through-hole;
an input/output coupling metallization on at least one surface of said at least one coaxial combline resonator;
at least one tunable varactor associated with said at least one coaxial combline resonator; and
an inter-pole-and-port cross coupling component cross coupling a filter pole of said at least one combline resonator and said at least one input-output coupling metallization.

2. The voltage-controlled tunable filter of claim 1, further comprising at least one DC biasing point for providing voltage to said at least one tunable varactor.

3. The voltage-controlled tunable filter of claim 1, wherein said at least one tunable varactor is four tunable varactors.

4. The voltage-controlled tunable filter of claim 1, wherein said at least one input/output coupling metallization on at least one surface of said at least one coaxial combline resonator is two input/output coupling metallizations on at least one surface of said at least one coaxial combline resonator.

5. The voltage-controlled tunable filter of claim 1, wherein said voltage-controlled tunable filter is a monoblock voltage controlled tunable filter.

6. The voltage-controlled tunable filter of claim 1, wherein said voltage-controlled tunable filter is a coaxial block voltage controlled tunable filter.

7. The voltage-controlled tunable filter of claim 1, wherein said inter-pole-and-port cross coupling component cross coupling a filter pole of said at least one combline resonator and said at least one input-output coupling metallization provides variable capacitive cross coupling.

8. The voltage-controlled tunable filter of claim 1, wherein said inter-pole-and-port cross coupling component cross coupling a filter pole of said at least one combline resonator and said at least one input-output coupling metallization provides variable inductive cross coupling.

9. The voltage-controlled tunable filter of claim 1, wherein said inter-pole-and-port cross coupling component cross coupling a filter pole of said at least one combline resonator and said at least one input-output coupling metallization provides variable capacitive and inductive cross coupling.

10. A voltage-controlled tunable filter, comprising:
at least one coaxial combline resonator;
said at least one coaxial combline resonator includes and at least one metallized through-hole;
a plurality of input/output coupling metallizations on at least one surface of said at least one coaxial combline resonator;
at least one tunable varactor associated with said at least one coaxial combline resonator; and
an inter-pole-and-port cross coupling component cross coupling at least two of said plurality of input/output coupling metallizations.

11. The voltage-controlled tunable filter of claim 10, further comprising at least one DC biasing point for providing voltage to said at least one tunable varactor.

12. The voltage-controlled tunable filter of claim 10, wherein said at least one tunable varactor is four tunable varactors.

13. The voltage-controlled tunable filter of claim 10, wherein said plurality of one input/output coupling metallizations on at least one surface of said at least one coaxial combline resonator is two input/output coupling metallizations on at least one surface of said at least one coaxial combline resonator, said two input/output coupling metallizations are cross coupled by an inter-pole-and-port cross coupling component.

14. The voltage-controlled tunable filter of claim 10, wherein said voltage-controlled tunable filter is a monoblock voltage controlled tunable filter.

15. The voltage-controlled tunable filter of claim 10, wherein said voltage-controlled tunable filter is a coaxial block voltage controlled tunable filter.

16. The voltage-controlled tunable filter of claim 10, wherein said inter-pole-and-port cross coupling component cross coupling at least two of said plurality of input/output coupling metallizations provides variable capacitive cross coupling.

17. The voltage-controlled tunable filter of claim 10, wherein said inter-pole-and-port cross coupling component cross coupling at least two of said plurality of input/output coupling metallizations provides variable inductive cross coupling.

18. The voltage-controlled tunable filter of claim 10, wherein said inter-pole-and-port cross coupling component cross coupling at least two of said plurality of input/output coupling metallizations provides variable capacitive and inductive cross coupling.

19. An RF filter, comprising:
at least one block of dielectric material;
at least one metallized through hole within said at least one block of dielectric material;
said at least one block of dielectric material having an electrode pattern that adheres to at least one surface of said block;
said electrode pattern consisting of a photodefinable metallization covering at least one surface of said block of dielectric material converted to a photodefined patterned metallization on at least one surface of said dielectric material and wherein said metallization includes at least one input/output coupling metallization and also includes at least one tunable varactor; and
an inter-pole-and-port cross coupling component cross coupling a filter pole of said at least one block of dielectric material and said at least one input-output coupling metallization.

20. The RF filter of claim 19, further comprising at least one additional block of dielectric material connected via an iris between said block of dielectric material and said at least one additional block of dielectric material.

21. The RF filter of claim 19, further comprising at least one DC biasing point for providing voltage to said at least one tunable varactor.

22. The voltage-controlled tunable filter of claim 19, wherein inter-pole-and-port cross coupling component cross coupling a filter pole of said at least one block of dielectric material and said at least one input-output coupling metallization provides variable capacitive cross coupling.

23. The voltage-controlled tunable filter of claim 19, wherein inter-pole-and-port cross coupling component cross coupling a filter pole of said at least one block of dielectric material and said at least one input-output coupling metallization provides variable inductive cross coupling.

24. The voltage-controlled tunable filter of claim 19, wherein inter-pole-and-port cross coupling component cross coupling a filter pole of said at least one block of dielectric material and said at least one input-output coupling metallization provides variable capacitive and inductive cross coupling.

25. A method of tuning transmission zeros using a voltage-controlled tunable filter, comprising the steps of:
providing at least one coaxial combline resonator;
said at least one coaxial combline resonator includes at least one metallized through-hole and an input/output coupling metallization on at least one surface of said at least one coaxial combline resonator;
varying the capacitance of a varactor by using at least one tunable varactor associated with said at least one coaxial combline resonator; and
cross coupling a filter pole of said at least one combline resonator and said at least one input-output coupling metallization with an inter-pole-and-port cross coupling component.

26. The method of tuning transmission zeros using a voltage-controlled tunable filter of claim 25, further comprising providing at least one DC biasing point for providing voltage to said at least one tunable varactor.

27. The method of tuning transmission zeros using a voltage-controlled tunable filter of claim 25, wherein said at least one tunable varactor is four tunable varactors.

28. The method of tuning transmission zeros using a voltage-controlled tunable filter of claim 25, wherein said least one input/output coupling metallization on at least one surface of said at least one coaxial combline resonator is two input/output coupling metallization on at least one surface of said at least one coaxial combline resonator.

29. The method of tuning transmission zeros using a voltage-controlled tunable filter of claim 25, wherein said voltage-controlled tunable filter is a monoblock voltage controlled tunable filter.

30. The method of tuning transmission zeros using a voltage-controlled tunable filter of claim 25, wherein said voltage-controlled tunable filter is a coaxial block voltage controlled tunable filter.

31. The method of tuning transmission zeros using a voltage-controlled tunable filter of claim 25, wherein said step of cross coupling a filter pole of said at least one combline resonator and said at least one input-output coupling metallization with an inter-pole-and-port cross coupling component provides variable capacitive cross coupling.

32. The method of tuning transmission zeros using a voltage-controlled tunable filter of claim 25, wherein said step of cross coupling a filter pole of said at least one combline resonator and said at least one input-output coupling metallization with an inter-pole-and-port cross coupling component provides variable inductive cross coupling.

33. The method of tuning transmission zeros using a voltage-controlled tunable filter of claim 25, wherein said step of cross coupling a filter pole of said at least one combline resonator and said at least one input-output coupling metallization with an inter-pole-and-port cross coupling component provides variable capacitive and inductive cross coupling.

34. A voltage-controlled tunable filter, comprising:
at least one coaxial combline resonator;
said at least one coaxial combline resonator includes and at least one metallized through-hole;
an input/output coupling metallization on at least one surface of said at least one coaxial combline resonator;
at least one MEM varactor associated with said at least one coaxial combline resonator; and
an inter-pole-and-port cross coupling component cross coupling a filter pole of said at least one combline resonator and said at least one input-output coupling metallization.

35. The voltage-controlled tunable filter of claim 34, wherein said MEM varactor has an interdigital topology.

36. The voltage-controlled tunable filter of claim 34, wherein said MEM varactor has a parallel plate topology.
